(19) United States
(12) Patent Application Publication
(10) Pub. No.: US 2005/0220062 A1
(43) Pub. Date: Oct. 6, 2005

(54) Wireless LAN system containing a plurality of access points

(75) Inventor: Takashi Kido, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/091,526

(22) Filed: Mar. 29, 2005

(30) Foreign Application Priority Data
Mar. 30, 2004 (JP) 2004-099256

(51) Int. Cl. H04L 12/28

(52) U.S. Cl. 370/338; 370/408

(57) ABSTRACT

In a wireless LAN system, a plurality of access points 20A to 20E are connected in the ring-forming manner using a spanning tree. The access points 20A to 20E operate in conjunction with management server 11 of roaming server 10. The standard of the wireless LAN system is the IEEE802.11b or IEEE802.11a, and the interface of the wireless LAN system is the 100Base-FX or 100Base-TX.

### BACKGROUND OF THE INVENTION

1. Field of the Invention

The present invention relates to a wireless LAN system and particularly, to a wireless LAN system that can avoid a communication failure.

2. Description of Related Art

Conventionally, there is provided a service in which, basically, a layer 2 switch and layer 3 switch (L2/3SW) and an access point are connected one-on-one correspondence.

There is disclosed in JPA 2002-368771 a spanning tree apparatus that comprises a first and second connection portions which are connected to a network, a communication path that can make the first and second connection portions communicate with each other, a switching means that switches the state of the communication path of the first and second connection portions between the communicable state and the incommunicable state, and a control means that detects the state of the network and controls to make the communication path incommunicable by using the switch means when the network is normally operated and make the communication path communicable by using the switch means when a communication failure occurs in the network so as to enable the network communication through the communication path.

However, in the above conventional technique, since the spanning tree apparatus detects the state of the communication path to select the communication path, the case in which data are transmitted from the access point side has not been considered.

Therefore, when transmitting data from the access point side, communication avoiding a point where a communication failure occurs has not been possible.

### SUMMARY OF THE INVENTION

It is therefore an object of the present invention to enable normal communication even though data is transmitted from the access point side.

To solve above-described problem, according to the present invention, there is provided a wireless LAN system comprising a plurality of access points which are connected in a ring-forming manner using a spanning tree, and a wireless communication terminal connected with any one of the plurality of access points.

Further, according to the present invention, there is provided an access point apparatus comprising a wireless LAN access point for judging one of two communication paths and a switch for selecting one of the communication paths based on the judgment of the access point device, wherein the switch is provided with a spanning tree protocol.

According to the present invention, since access points are connected using a spanning tree, and the communication path is selected from the access point side, even though there is a communication failure somewhere in a network between the access points, communication can be performed through the reverse path. Thus, even though data is transmitted from the access point side, communication can be normally carried out.

Further, according to the present invention, since a spanning tree protocol is utilized in the ring-forming manner, redundancy can be established at a reasonable price.

### BRIEF DESCRIPTION OF THE DRAWINGS

FIG. 1 shows a block diagram of a network system according to a first embodiment of the present invention;

FIG. 2 shows a block diagram of an access point 20 according to the first embodiment of the present invention; and

FIG. 3 is a flow chart showing the operation according to the first embodiment of the present invention.

### DETAILED DESCRIPTION OF THE PREFERRED EMBODIMENTS

Preferred embodiments of the present invention will be described below with reference to the accompanying drawings.

[Description of Configuration]

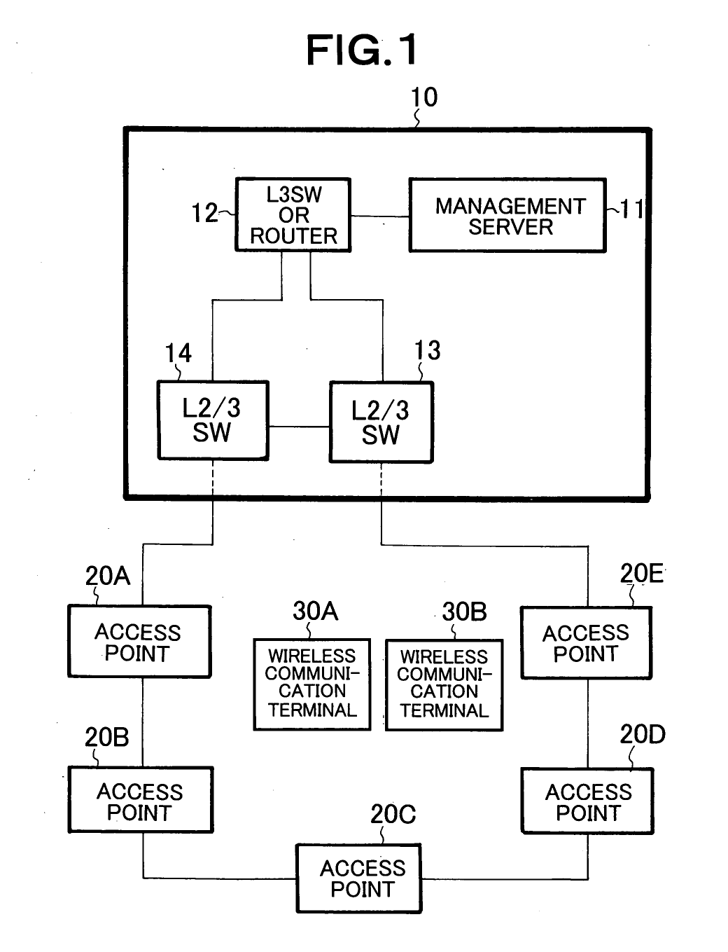

FIG. 1 is a block diagram showing a configuration according to the first embodiment of the present invention.

As shown in FIG. 1, in the embodiment, a plurality of access points 20A to 20E are connected in the ring-forming manner, and both ends of the ring are connected to roaming server 10.

In the embodiment, a wireless LAN system of the 100Base-FX standard is employed, and an optical fiber of a one-filament connection line is used.

The access points 20A to 20E are connected to wireless communication terminals 30A and 30B by employing a method of dial-up connection or the like from the wireless communication terminals 30A and 30B.

The roaming server 10 includes management server 11, L3SW or router 12, L2/3SW 13, and L2/3SW 14.

The management server 11 is handover/roaming server.

In the embodiment, since the necessity of confirming the state of the access points 20A to 20E (making the access points 20A to 20E report their state) is increased by employing the ring-forming network, the server 11 is referred to as a management server.

The L3SW is a Layer 3 switch and works as a network relay.

The L3SW judges the destination of packets by using data of a network layer (third layer) of the OSI reference model to transfer the packets. Since the IP is used as a protocol of a network layer in most cases, most L3SWs control paths by employing information and function of the IP. The L3SW transfers packets to an output port corresponding to a target IP address by using path control and routing function (Routing Information Protocol (RIP), Open Shortest Path First (OSPF), and BGF) by the IP address.

The router 12 is a commonly used router and analyzes part of a protocol of a network layer (third layer) and a transport layer (fourthlayer) of the OSI reference model to transfer packets, and is provided with a path selection function of judging which path should be used to transfer packets in reference to addresses of the network layer.

The L2/3SW 13 and the L2/3SW 14 are switches which can carry out the function of above-described L3SW and the function of an L2SW to be described later.

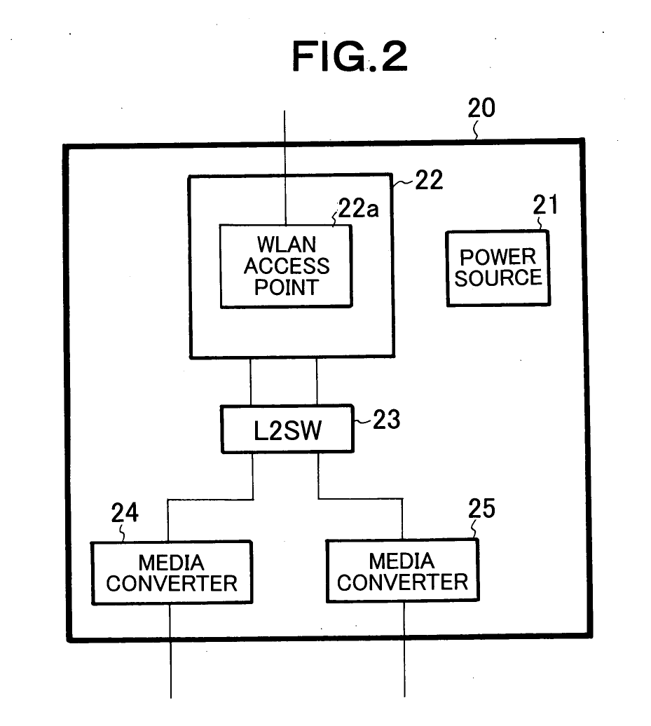

FIG. 2 shows a block diagram of an access point. In FIG. 2, of the access points 20A to 20E, configuration of the access point 20A is shown. Other access points 20B to 20E have the same configuration.

The access point 20A includes power source 21, expansion slot 22, L2SW23, media converter 24, and media converter 25.

The access point 20A has two ports working as connection portions for terminals, and is bases on the 100Base-FX standard.

The access points 20A to 20E of the embodiment operate in conjunction with the management server 11, and each of the access points 20A to 20E confirms the state with adjacent access point every constant period of time to send the result to the management server 11. When each access point is used in the hot spot manner, handover and roaming are accurately carried out.

The access points 20A to 20E of the embodiment use the IEEE802.11b. In this case, communication of 11 Mbps at a maximum is possible. When the IEEE802.11a is used, communication of 50 Mbps at a maximum is possible (indoors, basically). In case the IEEE802.11a is employed, so as to utilize bands effectively, bands are used effectively on the premise that credit or strict Qos function of the respective access points are used.

The power source 21 supplies electric power to the respective units of the access point 20A.

The expansion slot 22 has WLAN access point 22a, and the WLAN access point 22a judges which of the L2/3SW 13 or the L2/3SW 14 should be used to perform communication therethrough.

The L2SW 23 is a Layer 2 switch and works as one of network relays. The L2SW 23 judges the destination of packets by using data of a data link layer (second layer) of the OSI reference model to transfer the packets. As a protocol of a data link layer, there is a media access control (MAC), and the destination of data is determined referring to the MAC address.

The L2SW 23 of the embodiment is provided with a spanning tree protocol.

The media converters 24 and 25 are transmission media conversion units that convert the transmission media, for example, from optical fiber to copper wire cable. In the embodiment, it is supposed that optic/electric conversion is performed.

The wireless communication terminals 30A and 30B are communication terminals for a wireless LAN, Bluetooth or the like.

In the embodiment, the above-described access points 20A to 20E are connected in the ring-forming manner using a spanning tree.

The spanning tree is a control method that prevents data from circulating permanently in a loop-shaped (ring-shaped) network. The spanning tree is standardized as the IEEE802.1d. Under a given priority order, control information referred to as Bridge Protocol Data Unit (BPDU) is sent and received between bridges, and a single path is set up for usual use, while other paths are set up as circumvention paths at the time of a communication failure.

Under this configuration, even though a network physically forms a loop, data is prevented from circulating permanently in the loop. It is desired that the spanning tree be used in case of establishing a large-sized network, because network establishment can be easily performed by merely replacing bridges with corresponding devices and circumvention paths can be secured at the time of a communication failure, as compared the case of reestablishing a network and dissolving a loop. The embodiment is suitable for establishing a large-sized WLAN.

An optical fiber of a one-filament connection line is used in the embodiment, however an optical fiber of two-filament connection lines may be used.

[Description of Operation]

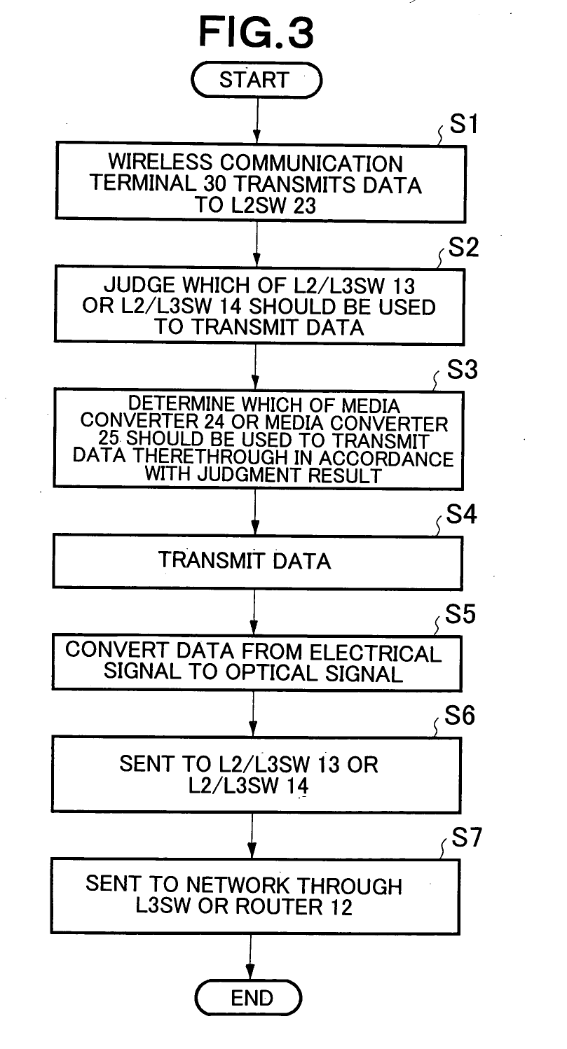

FIG. 3 is a flowchart showing the operation of the embodiment.

Firstly, the wireless communication terminal 30 (30A or 30B) transmits data to the L2SW 23 through the WLAN access point 22a of any one of the access points 20A to 20E (step S1).

Then, the WLAN access point 22a judges which of the L2/3SW 13 or the L2/3SW 14 should be used to transmit data therethrough (step S2), and determines which of the media converter 24 or the media converter 25 should be used to transmit data therethrough in accordance with the judgment result (step S3), and transmits data (step S4).

Data transmitted from the L2SW 23 is converted from an electrical signal to an optical signal by any one of the media converter 24 and the media converter 25 (step S5), and is sent to the L2/3SW 13 or the L2/3SW 14 through an optical fiber of a one-filament connection line (step S6), and is sent to a network, not shown, through the L3SW or router 12, thereby performing communication (step S7).

As described in the above, according to the embodiment, since the access points 20A to 20E are connected by using a spanning tree, even though there is a communication failure somewhere in a network between the access points 20A to 20E, communication can be performed using the reverse path.

[Other Embodiments]

As another embodiment of the present invention, the interface used in a network may be another interface such as the 100Base-TX.

In this case, attention has to be directed to the scale of a network and the level of bands.

AS above described, according to the embodiments, since the 100Base-FX standard is employed, a high speed and expandable network can be constructed.

Further, according to the embodiments, since the access points are configured in the ring-forming manner, port efficiency of an L2/3SW can be improved.

Furthermore, according to the embodiments, since the access points and switches respectively have the Qos function, bands are effectively utilized.

Further, according to the embodiments, since a wire is configured in the ring-forming manner, cost for laying optical fibers can be significantly reduced as compared with the one-on-one connection.

1. A wireless LAN system comprising a plurality of access points which are connected in a ring-forming manner using a spanning tree, and a wireless communication terminal connected with any one of said plurality of access points.

2. The wireless LAN system according to claim 1, wherein both ends of said access points connected in the ring-forming manner are connected a roaming server.

3. The wireless LAN system according to claim 2, wherein said access points operate in conjunction with a management server in said roaming server.

4. An access point apparatus comprising a wireless LAN access point for judging one of two communication paths and a switch for selecting one of the communication paths based on the judgment of said access point device, wherein said switch is provided with a spanning tree protocol.
